(19) United States
(12) Patent Application Publication
(10) Pub. No.: US 2026/0364993 A1
(43) Pub. Date: Nov. 19, 2026

(54) THERMAL SYSTEM FOR A MOTOR VEHICLE

(71) Applicant: AMPERE S.A.S., Boulogne Billancourt (FR)

(72) Inventors: David GERARD, Guyancourt (FR); Cedric LIBERT, Guyancourt (FR)

(73) Assignee: AMPERE S.A.S., Boulogne Billancourt (FR)

(21) Appl. No.: 19/140,201

(22) PCT Filed: Dec. 15, 2023
(86) PCT No.: PCT/EP2023/086120

§ 371 Date: Jun. 17, 2025

(30) Foreign Application Priority Data
Dec. 21, 2022 (FR) FR2214180

(51) Int. Cl. B60H 1/00

(52) U.S. Cl. CPC B60H 1/00735; B60H 1/004

(57) ABSTRACT

A thermal system is for a motor vehicle equipped with an electric motor and with an internal combustion engine. The thermal system includes a fuel cell capable of powering the electric motor, an aftertreatment system for exhaust gases of the combustion engine, and a circuit including a first set of lines. The first set of lines are arranged to enable a first circulation of a heat transfer fluid from the fuel cell to the aftertreatment system.

The invention relates to a thermal system for a motor vehicle. The invention also relates to a method for thermally managing a motor vehicle. The invention additionally relates to a motor vehicle equipped with a thermal system.

Engines/motors using hydrogen as a source of energy are mainly of two types. A first type consists in using hydrogen in a fuel cell powering an electric motor. A second type consists in using hydrogen as fuel in an internal combustion engine. The first and the second type of engine/motor both have advantages.

The advantages of an engine/motor of the first type include, in particular, a very high efficiency when using the vehicle at low power, and the absence of any regulated polluting emission when using an electric motor.

The advantages of an engine/motor of the second type relate to the possibility of generating high powers with a high efficiency. On the other hand, the internal combustion engine produces a small quantity of regulated pollutants.

U.S. Pat. No. 6,899,062B2 discloses a system which combines the two types of engine/motor and implements a cooling circuit that is shared between the first and second types of engine/motor. However, this thermal management solution is not optimal.

The aim of the invention is to provide a thermal system that remedies the drawbacks above and improves on the systems known from the prior art. In particular, the invention makes it possible to produce a thermal system which is reliable and efficient and which makes it possible to simplify the thermal management of the two types of engine/motor while optimizing the use conditions of each type of engine/motor.

To this end, the invention relates to a thermal system for a motor vehicle, the vehicle being equipped with an electric motor and with an internal combustion engine, comprising a fuel cell capable of powering the electric motor, an aftertreatment system for exhaust gases of the combustion engine and a circuit comprising a first set of lines, the first set of lines being arranged to enable a first circulation of a heat transfer fluid from the fuel cell to the aftertreatment system.

In one embodiment, the thermal system comprises a first heat exchanger comprising an inlet point for fluid into the first heat exchanger and an outlet point for fluid out of the first heat exchanger.

In addition, the circuit, the first set of lines of which connects a first point situated in the vicinity of the fuel cell and a second point situated in the vicinity of the aftertreatment system, also comprises:
a second set of lines connecting the outlet point and the first point, the second set of lines being arranged to enable a second circulation of heat transfer fluid for the cooling of the fuel cell, and/or
a third set of lines connecting the outlet point and a third point, situated in the vicinity of the combustion engine, the third set of lines being arranged to enable a third circulation of heat transfer fluid for the cooling of the combustion engine, and/or
a fourth set of lines connecting the outlet point and a fourth point, situated in the vicinity of the electric motor, the fourth set of lines being arranged to enable a fourth circulation of heat transfer fluid for the cooling of the electric motor.

In one embodiment, the circuit further comprises:
a fifth set of lines connecting the first point and the third point, the fifth set of lines being arranged to enable a fifth circulation of heat transfer fluid from the fuel cell to the combustion engine, and/or
a sixth set of lines connecting the third point and the first point, the sixth set of lines being arranged to enable a sixth circulation of heat transfer fluid from the combustion engine to the fuel cell, and/or
a seventh set of lines connecting the second point and the first point, the seventh set of lines being arranged to enable a seventh circulation of heat transfer fluid from the aftertreatment system to the fuel cell.

In one embodiment, the fuel used by the fuel cell is dihydrogen, and/or the fuel cell is of the proton-exchange membrane type, and/or the fuel cell is of the high-temperature proton-exchange membrane type.

In one embodiment, the heat transfer fluid is a liquid-phase synthetic heat transfer fluid, and/or the heat transfer fluid is effective over a temperature range with an extent greater than or equal to 100 degrees, or even greater than or equal to 200 degrees, notably over a temperature range of −40 °C to 200 °C, or even over a temperature range of −85 °C to 260 °C.

In one embodiment, the aftertreatment system comprises a line portion for the flow of exhaust gases containing a catalytic converter, and the circuit comprises a second heat exchanger for implementing a transfer of heat between a heat transfer fluid circulating in the second heat exchanger and the line portion. In addition, the line portion and a heat exchange surface of the second heat exchanger are of cylindrical shape, and the heat exchange surface surrounds the line portion.

In addition or as an alternative, the heat transfer fluid circulates in a direction opposite to a flow direction of the exhaust gases in the line portion.

The invention also relates to a method for thermally managing a motor vehicle equipped with a fuel cell, with an electric motor, with a combustion engine, with an aftertreatment system for exhaust gases of the combustion engine, and with a thermal system according to the invention, comprising an iteration of the following steps:
a first step of thermally managing an operating phase of the fuel cell and of the electric motor, then
a second step of anticipating when the combustion engine and the aftertreatment system will next be started, then
a third step of thermally managing an operating phase of the combustion engine and of the aftertreatment system, then
a fourth step of anticipating when the fuel cell will next be started, and the second step comprises an implementation of the first circulation of heat transfer fluid and, optionally, an implementation of the fifth circulation of heat transfer fluid.

In one embodiment of the thermal management method:
the first step and the second step comprise an implementation of the second circulation and of the fourth circulation of heat transfer fluid, and/or
the third step and the fourth step comprise an implementation of the third circulation of heat transfer fluid, and/or
the fourth step comprises an implementation of the sixth circulation and/or of the seventh circulation of heat transfer fluid.

The invention also relates to a thermal management system according to the invention, the system comprising hardware and/or software elements implementing the method according to the invention, notably hardware and/or software elements designed to implement a method according to the invention.

The invention also relates to a motor vehicle equipped with a thermal system for thermal management according to the invention.

These subjects, features and advantages of the present invention will be set out in detail in the following description of one particular embodiment given by way of nonlimiting example with reference to the attached figures among which:

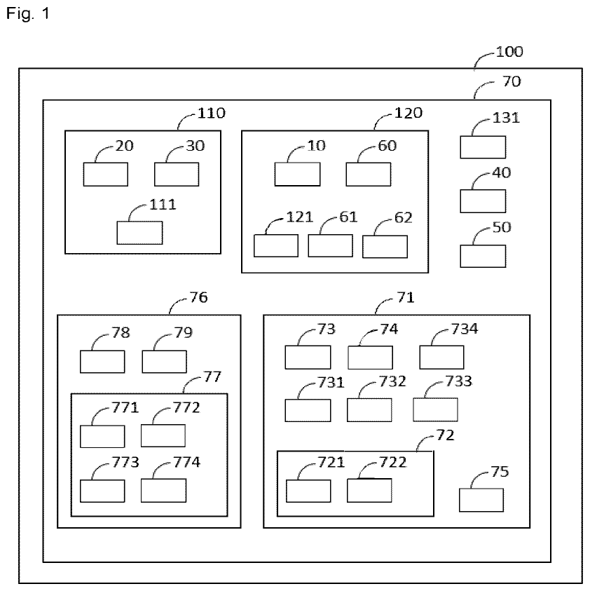

FIG. 1 schematically shows a motor vehicle equipped with a thermal system according to one embodiment of the invention.

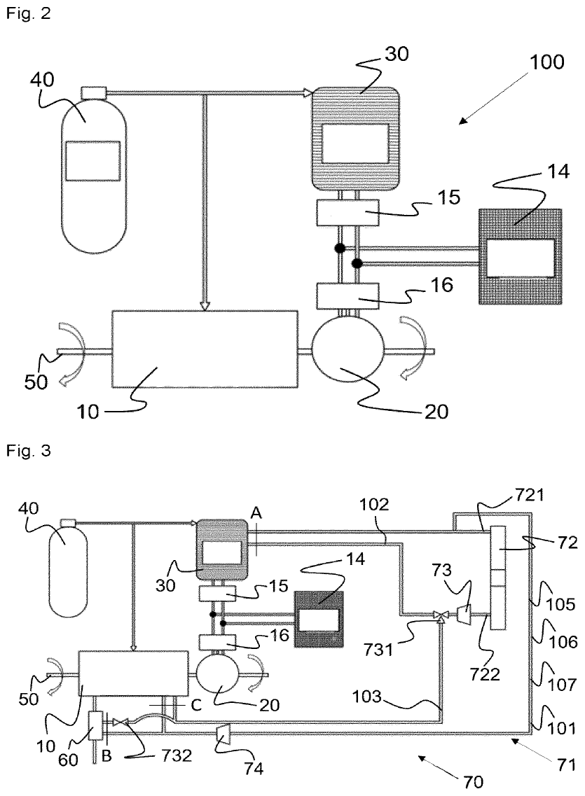

FIG. 2 shows a vehicle equipped with an electric motor powered by a fuel cell and with a hydrogen heat engine.

FIG. 3 illustrates a first embodiment of a thermal system according to the invention.

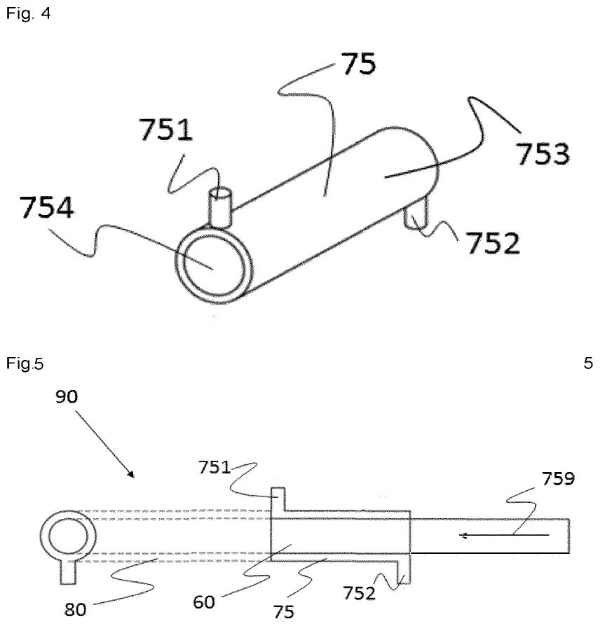

FIG. 4 is a perspective view of one embodiment of a heat exchanger for an aftertreatment system.

FIG. 5 shows an aftertreatment system equipped with a heat exchanger for an aftertreatment system.

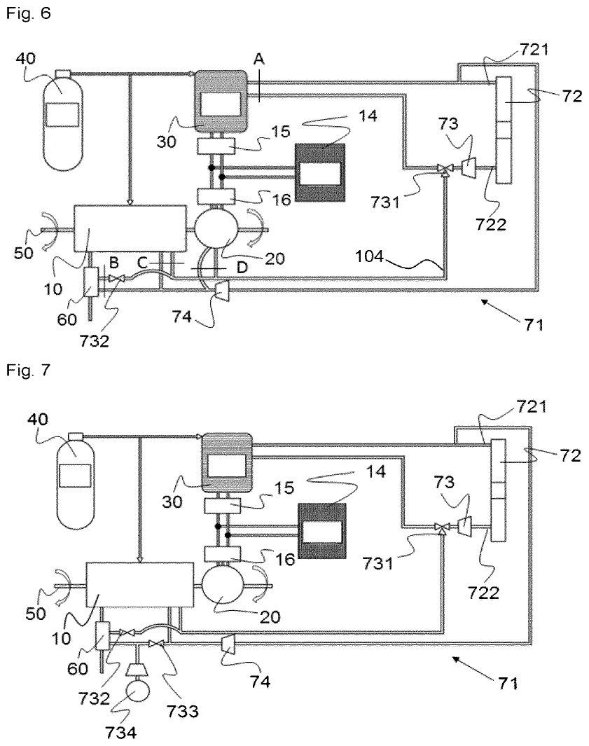

FIG. 6 illustrates a second embodiment of a thermal circuit according to the invention.

FIG. 7 illustrates a third embodiment of a thermal circuit according to the invention.

One embodiment of a motor vehicle 100 according to the invention is described below with reference to FIGS. 1 and 2. The motor vehicle 100 is a motor vehicle of any type, notably a passenger vehicle or a commercial vehicle. The motor vehicle 100 is a hydrogen vehicle, that is to say a vehicle which uses energy from the oxidation of hydrogen in order to move.

In one embodiment which is more specifically described in this document, the motor vehicle 100 is a hybrid vehicle comprising both a first hydrogen-operated internal combustion engine 10 and a second electric motor 20 powered by electrical energy from a fuel cell 30 supplied with hydrogen. In the remainder of the document, the first engine 10 is called combustion engine 10 or heat engine 10.

In the remainder of the document, a thermal system 70 responsible for the thermal management of the first engine and second motor of the motor vehicle 100 is defined. The thermal system 70 comprises the first engine 10 and second motor 20 and the fuel cell 30.

For the operation thereof, the fuel cell 30 has to be associated with a high-voltage battery 14, and with two converters 15, 16. The battery 14 provides energy to the electric motor in specific situations, for example in a phase for starting the electric motor, when the fuel cell has not yet reached its optimal operating temperature. The battery 14 also makes it possible to very rapidly provide a high power in a transient driving phase.

According to one embodiment, the fuel cell 30 comprises three elements: an oxidizing anode which emits electrons, a reducing cathode which collects electrons, and an electrolyte which separates them. A tank supplies the two electrodes with fuel, the anode receiving hydrogen and the cathode oxygen. The anode oxidizes the fuel, then releases electrons that the electrolyte will force to pass through an external circuit. This generates a DC electric current. This process is called “oxidation”. For its part, the oxygen present in the cathode will react on contact with electrons released by the reaction described above. This is a “reduction” which produces heat and water.

In order to enable the first engine and the second motor to operate, the thermal system 70 further includes:
a hydrogen storage system 40 comprising an interface for the filling thereof and making it possible to supply hydrogen to the combustion engine 10 and the fuel cell 30,
a transmission shaft 50 connected to the first engine 10 and to the second motor 20 and transmitting a rotational movement to the wheels of the motor vehicle 100,
an aftertreatment system 60 for exhaust gases of the first engine 10.

The purpose of the aftertreatment system 60 is to process the nitrogen oxides generated by the heat engine 10 during the combustion of hydrogen. The aftertreatment system makes it possible to generate dinitrogen molecules from the nitrogen oxides.

The thermal system 70 comprising a thermal circuit 71 according to the 15 invention, the thermal circuit 71 making it possible to manage
for the one part, the cooling of the fuel cell 30 and of the first engine 10, and,
for the other part, the heating of the aftertreatment system 60.

Furthermore, during a period of time preceding a transition between a driving phase using the heat engine and a driving phase using the electric motor, the thermal circuit 71 can make it possible to use the heat generated by the heat engine and/or the post-combustion system to heat the fuel cell 30 in order to bring it to a temperature close to its operating temperature, for example a temperature close to 100 degrees.

In addition, during a period of time preceding a driving phase using the electric motor and a driving phase using the heat engine, the thermal circuit 71 can make it possible to heat the aftertreatment system and/or the heat engine in order to bring it to a temperature close to its operating temperature, for example a temperature close to 100 degrees.

In the various embodiments shown by FIGS. 3 to 5, the thermal circuit 71 comprises:
a first set of lines 101 connecting a first point A situated in the vicinity of the fuel cell and a second point B situated in the vicinity of the aftertreatment system 60,
a heat exchanger 72 having an inlet 721 and an outlet 722 for the heat transfer fluid,
a first pump 73 placed downstream of the outlet 722, generating a circulation of a cooled heat transfer fluid to a three-way valve 731, making it possible to direct the heat transfer fluid to the fuel cell and/or the heat engine and/or the electric motor for the cooling thereof,
a second pump 74 placed upstream of the inlet 721, generating a circulation of a heated heat transfer fluid through a passage in the vicinity of the heat engine and/or in the vicinity of the aftertreatment system 60 and/or in the vicinity of the fuel cell during operation.

The implementation, by the thermal circuit 71, of cooling or of heating of a given element of the thermal system 40 (the given element being able to be, for example, the fuel cell or the aftertreatment system 60) requires a portion of the thermal circuit 71 to be disposed at a small distance from said given element. In other words, a portion of the thermal circuit 71 has to circulate at a sufficiently small distance from said given element to allow a transfer of heat between the portion of the thermal circuit and said given element.

In the remainder of the document, the expression “the point X is in the vicinity of the element Y” should be interpreted as meaning “the point X is at a sufficiently small distance from the element Y to allow a transfer of heat between a heat transfer fluid circulating at point X and the element Y”.

For example, the expression “a first point A situated in the vicinity of the fuel cell” should be interpreted as “a first point A situated at a sufficiently small distance from the fuel cell to allow a transfer of heat between a heat transfer fluid circulating at point A and the fuel cell”.

The expression “in the vicinity of” may also be used to pinpoint a portion of the thermal circuit 71 at a sufficiently small distance from a given element to allow a transfer of heat between said portion of the thermal circuit 71 and the given element.

In the remainder of the document, the expressions “point A”, “point B”, “point C” or “point D” are used to denote a portion of the circuit 71 that is located in the vicinity of an element to be cooled or to be heated. For example, the term “point A” denotes a portion of the circuit 71 that is located in the vicinity of the fuel cell 30. Depending on the context in which it is used, the term “point A” may denote either a zone upstream of the fuel cell 30 relative to the direction of circulation of the heat transfer fluid, or a zone downstream of the fuel cell 30 relative to the direction of circulation of the heat transfer fluid.

The circuit 71 comprises a first shut-off valve 732 disposed on a portion of the circuit for admitting cold heat transfer fluid in the vicinity of the aftertreatment system 60. The first shut-off valve 732 offers the possibility of cooling the heat engine 10 without cooling the aftertreatment system 60.

In one embodiment presented below with reference to FIG. 7, the circuit 71 further comprises a second shut-off valve 733.

Thus, the thermal circuit 71 comprises a first set of lines 101 arranged to enable a first circulation of a heat transfer fluid between a first point A situated in the vicinity of the fuel cell and a second point B situated in the vicinity of the aftertreatment system 60, so as to implement a transfer of heat from the fuel cell 30 to the aftertreatment system 60.

In other words, the first set of lines 101 makes it possible to heat the aftertreatment system 60 using the heat generated by the fuel cell 30. The first circulation is particularly advantageous in a time interval preceding a transition between an operating phase of the electric motor 20 and an operating phase of the heat engine 10, requiring the aftertreatment system 60 to be started. Thus, when it is started, the aftertreatment system 60 will have to have been preheated by the implementation of the first circulation.

The feasibility and the efficiency of such preheating of the aftertreatment system 60 requires matching between the temperature of the heat transfer fluid and an optimal temperature for the operation of the aftertreatment system 60.

However, the temperature of the heat transfer fluid is notably dependent on the operating temperature of the fuel cell 30. In particular, a fuel cell of the proton-exchange membrane type may heat the heat transfer fluid to a temperature of approximately 100 degrees, thus allowing the aftertreatment system 60 to reach this temperature prior to it being started, by virtue of the implementation of the first circulation 101.

The temperature of 100 degrees thus reached by the aftertreatment system 60 is below the minimum temperature from which it can operate, which is generally around 200 degrees. This is notably the case for aftertreatment systems that use what is known as “selective catalytic reduction” catalysis technology. This technology, which is the most suitable for neutralizing the nitrogen oxide molecules emitted by the combustion engine 10, is effective as soon as the catalytic converter reaches a temperature above 200 or 225 degrees.

The preheating of the aftertreatment system makes it possible to reduce the time for increasing the temperature of the aftertreatment system 60 to the minimum operating temperature of the catalytic converter, and therefore to reduce the quantity of nitrogen oxide molecules emitted between an instant of starting the combustion engine 10 and an instant at which the catalytic converter reaches an optimal operating temperature. In the case of an electrically assisted aftertreatment system for example, the preheating of the aftertreatment system also makes it possible to reduce the electrical energy necessary for bringing the aftertreatment system 60 to its minimum operating temperature.

As an alternative, a second type of proton-exchange membrane fuel cell, known as a “high-temperature” proton-exchange membrane fuel cell, may heat the heat transfer fluid to a temperature of approximately 200 degrees. In this case, the preheating of the aftertreatment system 60 is particularly advantageous because it allows the catalytic converter to reach its optimal operating temperature prior to the instant of starting the combustion engine 10.

The choice of the heat transfer fluid should be made depending on an operating temperature range of the various components that are intended to be cooled or heated by the thermal circuit 71. Such a choice influences the efficiency of a transfer of temperature between a heat source (the fuel cell 30 in the case of the first circulation) and an element to be heated (the aftertreatment system 60 in the case of the first circulation). Some fluids have very broad operating ranges. Notably, some liquid-phase synthetic heat transfer fluids have excellent heat transfer properties over a broad range of temperatures. They are thus very advantageous for applications demanding effective cooling and heating ranges and offer excellent heat transfer rates, even at −45 °C, the recommended temperature range of use thereof being between −85 °C and 260 °C.

FIG. 3 shows a first embodiment of a circuit 71 in which the fuel cell 30, the combustion engine 10 and the aftertreatment system 60 are connected to the circuit 71, whereas the electric motor 20 is not connected to the circuit 71.

FIG. 6 shows a second embodiment of a circuit 71 in which the fuel cell 30, the electric motor 20, the combustion engine 10 and the aftertreatment system 60 are connected to the circuit 71.

FIG. 7 shows a third embodiment of a circuit 71, which is a variant of the first embodiment, in which a purge system 734 for the heat transfer fluid and a second shut-off valve 733 have been added, in the part of the cooling circuit relative to the aftertreatment system 60. The purge system 734 makes it possible to drain the heat transfer liquid in contact with the aftertreatment system when the latter is at a very high temperature, for example during phases where it has reached its operating temperature.

In an advantageous embodiment of the thermal system 70, the circuit 71 further comprises a second heat exchanger 75 intended to promote a transfer of heat between the heat transfer fluid and a line portion of the aftertreatment system containing a catalytic converter. To this end, the second heat exchanger has a heat exchange surface 754 for exchanging heat with the first line portion.

FIGS. 4 and 5 illustrate one embodiment of a second heat exchanger 75. FIG. 5 shows an exhaust system 90 comprising an aftertreatment system 60 disposed upstream of an exhaust line 80 relative to a direction of circulation 759 of the exhaust gases. The second heat exchanger 75 is disposed in the vicinity of the line portion of the aftertreatment system containing a catalytic converter.

In the embodiment presented, the line portion and the heat exchange surface 754 of the second exchanger 75 are of cylindrical shape. Advantageously, the cylindrical line portion is disposed inside the cylinder formed by the heat exchange surface 754, such that the heat exchange surface 754 surrounds the line portion.

The heat exchange fluid in the circuit 71 circulates in the second heat exchanger 75, between an inlet point 751 of the second heat exchanger 75 and an outlet point 752 of the second heat exchanger 75, in a space delimited by an outer surface 753 and an inner surface 754 of the second heat exchanger 75. The inner surface 754 plays the role of heat exchange surface for exchanging heat with the first line portion; notably it implements a transfer of heat between a heat transfer fluid circulating in the second heat exchanger 75 and the first line portion.

In one embodiment, the inlet point 751 of the second heat exchanger 75 and the outlet point 752 of the second heat exchanger 75 are disposed such that the heat transfer fluid flows in a direction opposite to a flow direction of the exhaust gases.

In addition, the thermal circuit 71 provides means for implementing different circulations of heat transfer fluid that are intended to cool components, notably that are intended to cool the electric motor 20, the combustion engine 10 and the fuel cell 30 during their operation.

Thus, the circuit 71 comprises
a second set of lines 102 connecting the outlet point 722 of the first exchanger 72 and the first point A, the second set of lines 102 being arranged to enable a second circulation of heat transfer fluid for the cooling of the fuel cell 30, and/or
a third set of lines 103 connecting the outlet point 722 of the first exchanger 72 and a third point C, situated in the vicinity of the combustion engine 10, the third set of lines 103 being arranged to enable a third circulation of heat transfer fluid for the cooling of the combustion engine 10.

In addition, in one embodiment shown by FIG. 6, the motor vehicle 100 is also equipped with an electric motor 20, and the thermal circuit 71 comprises a fourth set of lines 104 connecting the outlet point 722 and a fourth point D, situated in the vicinity of the electric motor 20, the fourth set of lines 104 being arranged to enable a fourth circulation of heat transfer fluid for the cooling of the electric motor 20.

Furthermore, other circulations of fluid are conceivable, notably during a time interval preceding starting of either of the engine or motor.

Thus, in addition to the first set of lines 101 described above, the circuit 71 advantageously comprises other means for preheating one of the engine 10 or motor 20, or the fuel cell, from among:
a fifth set of lines 105 connecting the first point A and the third point C, the fifth set of lines 105 being arranged to enable a fifth circulation of heat transfer fluid from the fuel cell 30 to the combustion engine 10, and/or
a sixth set of lines 106 connecting the third point C and the first point A, the sixth set of lines 106 being arranged to enable a sixth circulation of heat transfer fluid from the combustion engine 10 to the fuel cell 30, and/or
a seventh set of lines 107 connecting the second point B and the first point A, the seventh set of lines 107 being arranged to enable a seventh circulation of heat transfer fluid from the aftertreatment system 60 to the fuel cell 30.

In order to implement preheating of one of the engine 10 or motor 20, or of the fuel cell, the thermal system 70 advantageously comprises a means for detecting the next changeover between use of the combustion engine and use of the electric motor.

In one embodiment,
a first subsystem 110 comprising the fuel cell 30 and the electric motor 20 is controlled by a first digital controller 111, and
a second subsystem 120 comprising the combustion engine 10 and the aftertreatment system 60 is controlled by a second digital controller 121.

The first and second digital controllers 111, 121 are controlled by a central controller 131 which manages the vehicle energy management laws. The detection of the next instance of needing to start one of the first or second subsystems 110, 120 (for example in order to optimize consumption) is effected at the central controller 131. This information is then transmitted to at least one of the first and second digital controllers 111, 121. The digital controller 111, 121 of the system starting next commands the starting of the preheating of said system.

In this embodiment, the thermal system 70 may communicate with the digital controllers 111, 121 in order to detect the next changeover between use of the combustion engine and use of the electric motor.

In an advantageous embodiment, the thermal system 70 further comprises the means for implementing a thermal management method according to the invention. Notably, the thermal system 70 comprises a processing unit 76 comprising a microprocessor 77, a memory 78 and communication interfaces 79.

The thermal system 70, and particularly the microprocessor 77, comprises mainly the following modules which cooperate with one another:
a module 771 for thermally managing an operating phase of the fuel cell and of the electric motor, this module being able to cooperate with the pump 73 and the three-way valve 731,
a module 772 for anticipating when the combustion engine and the aftertreatment system will next be started, this module being able to cooperate with the second digital controller 121 and the pump 74,
a module 773 for thermally managing an operating phase of the combustion engine and of the aftertreatment system, this module being able to cooperate with the pump 73, the three-way valve 731, the first shut-off valve 732 and the second shut-off valve 733,
a module 774 for anticipating when the fuel cell and the electric motor will next be started, this module being able to cooperate with the first digital controller 111 and the pump 74.

The motor vehicle 100, in particular the thermal system 70, preferably comprises all the hardware and/or software elements configured so as to implement the method defined in the subject matter of the invention or the method described below.

The method comprises an iteration through:
a first step E1 of thermally managing an operating phase of the fuel cell and of the electric motor, then
a second step E2 of anticipating when the combustion engine and the aftertreatment system will next be started, then
a third step E3 of thermally managing an operating phase of the combustion engine and of the aftertreatment system, then
a fourth step E4 of anticipating when the fuel cell and the electric motor will next be started,
   the second step E2 comprising an implementation of the first circulation of heat transfer fluid and, optionally, an implementation of the fifth circulation of heat transfer fluid.

In the first step E1, the first subsystem 110 comprising the fuel cell 30 and the electric motor 20 is started and controlled by the first digital controller 111.

In one embodiment, an order to start the cooling is then received from the first digital controller 111.

The pump 73 is then put into operation if it had not already been started, and the three-way valve 731 is configured to implement the second circulation of fluid 102 between the outlet point 722 of the first heat exchanger 72 and the first point A situated in the vicinity of the fuel cell 30, for the cooling of the fuel cell 30. In addition, the three-way valve 731 is also configured to implement the fourth circulation of fluid 104 between the outlet point 722 of the first heat exchanger 72 and the fourth point D situated in the vicinity of the electric motor 20, for the cooling of the electric motor 20.

The method then proceeds to step E2 of anticipating when the combustion engine and the aftertreatment system 60 will next be started. In step E2, a notification of when the second subsystem 120 comprising the combustion engine 10 and the aftertreatment system 60 will next be started is awaited, the notification being able to come from the second digital controller 121.

On receipt of a notification of when the second subsystem 120 will next be started, the first circulation of heat transfer fluid between the fuel cell 30 and the aftertreatment system 60 is implemented. To do so, the second pump 74 is then put into operation if it had not already been started.

In one embodiment in which the circuit 71 comprises a second heat exchanger 75 according to the embodiment described above with reference to FIG. 6, the heating of the aftertreatment system 60 is then effected by the passage of the heat transfer fluid between the inlet point 751 of the second heat exchanger 75 and the outlet point 752 of the second heat exchanger 75.

In addition, in step E2, the fifth circulation of heat transfer fluid between the fuel cell 30 and the combustion engine 10 may also be implemented, for the heating of the combustion engine 10.

Then, a notification of when the second subsystem 120 will next be started is awaited, the notification being able to come from the second digital controller 121. When such a notification is received, the method proceeds to step E3.

In step E3, the three-way valve 731 is configured to implement the third circulation of heat transfer fluid 103 between the outlet point 722 and the third point C situated in the vicinity of the combustion engine 10, for the cooling of the combustion engine 10. Advantageously, a first shut-off valve 732 is configured such that it prevents the passage of cold cooling fluid in the vicinity of the aftertreatment system 60. The implementation of the fifth circulation of heat transfer fluid is moreover interrupted, in order to interrupt the heating of the combustion engine 10 by the fuel cell 30.

Advantageously, the first shut-off valve 732 is closed in order to prevent the cooling of the aftertreatment system 60.

If the circuit 71 is realized according to the third embodiment described above with reference to FIG. 6, the second shut-off valve 733 may also be closed in order to prevent the aftertreatment system from transmitting too great a quantity of heat to the heat transfer fluid. In the cases where the temperature reached by the aftertreatment system 60 is considerably greater than an operating temperature of the fuel cell 30, the purge system 734 is then activated in order to store the heat transfer fluid which has been heated by the aftertreatment system 60. The fluid thus stored will be reinjected subsequently when the aftertreatment system will require heating again prior to it being started.

The method then proceeds to step E4 of anticipating when the fuel cell will next be started. In step E4, a notification of when the first subsystem 110 comprising the fuel cell and the electric motor will next be started is awaited, the notification being able to come from the first digital controller 111.

On receipt of a notification of when the first subsystem 110 will next be started, the sixth circulation of heat transfer fluid between the heat engine 10 and the fuel cell 30 is implemented. To do so, the second pump 74 is started if it has not yet been started.

In addition or as an alternative, the seventh circulation of heat transfer fluid between the aftertreatment system 60 and the fuel cell 30 is implemented.

To do so, if the circuit 71 comprises a purge system 734 and if the purge system 734 has been activated, the purge system 734 is deactivated. Moreover, if the second shut-off valve 733 has been closed, it is opened.

Step E1 is then returned to.

Table 1 provides a summary of the various circulations of heat transfer fluid that are capable of being implemented by the thermal circuit according to the invention depending on a changeover between use of a combustion engine 10 and use of an electric motor 20.

TABLE 1

| | | | | |
|---|---|---|---|---|
| Phase of | Phase of | Phase of | Phase of | Phase of |
| running | running with | transition | running with | transition |
| | the electric | between the | the heat | between the |
| | motor | electric motor | engine | electric motor |
| | | and the heat | | and the heat |
| | | engine | | engine |
| Thermal | The fuel cell is | The fuel cell is | The fuel cell is | The fuel cell is |
| management of | operating and | operating and | not operating. | not operating. |
| the fuel cell | is cooled by | is cooled by | No thermal | It is heated by |
| | the second | the second | management. | the sixth |
| | circulation of | circulation of | | circulation of |
| | fluid. | fluid. | | fluid or the |
| | | | | seventh |
| | | | | circulation of |
| | | | | fluid. |
| Thermal | The electric | The electric | The electric | The electric |
| management of | motor is | motor is | motor is not | motor is not |
| the electric | operating and | operating and | operating. No | operating. No |
| motor | is cooled by | is cooled by | thermal | thermal |
| | the fourth | the fourth | management. | management. |
| | circulation of | circulation of | | |
| | fluid. | fluid. | | |
| Thermal | The heat | The heat | The heat | The heat |
| management of | engine is not | engine is not | engine is | engine is |
| the combustion | operating. No | operating. It is | operating. It is | operating. It is |
| engine | thermal | heated by the | cooled by the | cooled by the |
| | management. | fifth circulation | third circulation | third circulation |
| | | of fluid. | of fluid. | of fluid. |
| Thermal | The | The | The | The |
| management of | aftertreatment | aftertreatment | aftertreatment | aftertreatment |
| the | system is not | system is not | system is | system is |
| aftertreatment | operating. No | operating. It is | operating. | operating. No |
| system | thermal | heated by the | No thermal | thermal |
| | management. | first circulation | management. | management. |
| | | of fluid. | | |
| Operation of the | The purge is | The purge is | The purge may | The purge is |
| purge | not operating. | not operating. | be operating. | not operating. |

The first row of table 1 defines various driving phases of the motor vehicle 100:
a first phase of running with the electric motor, without anticipation of when the combustion engine will next be used, corresponding to step E1,
a second phase of running with the electric motor, with anticipation of when the combustion engine will next be used, corresponding to step E2,
a third phase of running with the combustion engine, without anticipation of when the electric motor will next be used, corresponding to step E3,
a fourth phase of running with the combustion engine, with anticipation of when the electric motor will next be used, corresponding to step E4.

The second row of table 1 describes the circulations of heat transfer fluid that are implemented for the thermal management of the fuel cell, according to the four driving phases listed above.

The third row of table 1 describes the circulations of heat transfer fluid that are implemented for the thermal management of the electric motor, according to the four driving phases listed above.

The fourth row of table 1 describes the circulations of heat transfer fluid that are implemented for the thermal management of the combustion engine, according to the four driving phases listed above.

The fifth row of table 1 describes the circulations of heat transfer fluid that are implemented for the thermal management of the aftertreatment system, according to the four driving phases listed above.

The sixth row of table 1 describes the operation of the purge system 734, according to the four driving phases listed above.

In one embodiment that is not described in detail in this document, the combustion engine 10 and the electric motor 20 could be used simultaneously.

Ultimately, the thermal system according to the invention makes it possible to incorporate all of the thermal needs of both the engine and motor, of the fuel cell and of the aftertreatment system by implementing a single heat transfer fluid circuit. The single circuit makes it possible to cool one and/or the other of the engine and motor, and the fuel cell during the operation of the electric motor. The single circuit also makes it possible to preheat the aftertreatment system, the heat engine and/or the fuel cell prior to them being started, notably when the engine/motor are used alternatingly.

The preheating implemented by virtue of the thermal system makes it possible to reduce a phase of increasing the temperature of the aftertreatment system; it therefore makes it possible to effectively reduce the nitrogen oxide emissions from the heat engine, and does so from when the heat engine is started.

The preheating implemented by virtue of the thermal system also makes it possible to reduce the duration of a phase of increasing the temperature of the fuel cell, during which phase the high-voltage battery has to be used. Thus, by virtue of the thermal system, when the fuel cell and the electric motor are started, the duration of use of the high-voltage battery is reduced, thus improving the energy efficiency of the vehicle.

1-10. (canceled)

11. A thermal system for a motor vehicle, the vehicle being equipped with an electric motor and with an internal combustion engine, the thermal system comprising:
a fuel cell configured to power the electric motor;
an aftertreatment system for exhaust gases of the combustion engine; and
a circuit comprising a first set of lines, the first set of lines being arranged to enable a first circulation of a heat transfer fluid from the fuel cell to the aftertreatment system.

12. The thermal system as claimed in claim 11, further comprising a first heat exchanger comprising an inlet point for fluid into the first heat exchanger and an outlet point for fluid out of the first heat exchanger,
wherein in the circuit, the first set of lines of which connects a first point situated in a vicinity of the fuel cell and a second point situated in a vicinity of the aftertreatment system, further comprises:
a second set of lines connecting the outlet point and the first point, the second set of lines being arranged to enable a second circulation of heat transfer fluid for cooling of the fuel cell, and/or
a third set of lines connecting the outlet point and a third point, situated in a vicinity of the combustion engine, the third set of lines being arranged to enable a third circulation of heat transfer fluid for cooling of the combustion engine, and/or
a fourth set of lines connecting the outlet point and a fourth point, situated in a vicinity of the electric motor, the fourth set of lines being arranged to enable a fourth circulation of heat transfer fluid for cooling of the electric motor.

13. The thermal system as claimed in claim 12, wherein the circuit further comprises:
a fifth set of lines connecting the first point and the third point, the fifth set of lines being arranged to enable a fifth circulation of heat transfer fluid from the fuel cell to the combustion engine, and/or
a sixth set of lines connecting the third point and the first point, the sixth set of lines being arranged to enable a sixth circulation of heat transfer fluid from the combustion engine to the fuel cell, and/or
a seventh set of lines connecting the second point and the first point, the seventh set of lines being arranged to enable a seventh circulation of heat transfer fluid from the aftertreatment system to the fuel cell.

14. The thermal system as claimed in claim 11, wherein fuel used by the fuel cell is dihydrogen, and/or the fuel cell is of a proton-exchange membrane type, and/or the fuel cell is of a high-temperature proton-exchange membrane type.

15. The thermal system as claimed in claim 11, wherein the heat transfer fluid is a liquid-phase synthetic heat transfer fluid, and/or the heat transfer fluid is effective over a temperature range with an extent greater than or equal to 100 degrees.

16. The thermal system as claimed in claim 11, wherein the heat transfer fluid is a liquid-phase synthetic heat transfer fluid, and/or the heat transfer fluid is effective over a temperature range with an extent greater than or equal to 200 degrees.

17. The thermal system as claimed in claim 11, wherein the heat transfer fluid is a liquid-phase synthetic heat transfer fluid, and/or the heat transfer fluid is effective over a temperature range of −40 °C to 200 °C.

18. The thermal system as claimed in claim 11, wherein the heat transfer fluid is a liquid-phase synthetic heat transfer fluid, and/or the heat transfer fluid is effective over a temperature range of −85 °C to 260 °C.

19. The thermal system as claimed in claim 11, wherein the aftertreatment system comprises a line portion for a flow of exhaust gases containing a catalytic converter, the circuit comprises a second heat exchanger to implement a transfer of heat between a heat transfer fluid circulating in the second heat exchanger and the line portion,
wherein the line portion and a heat exchange surface of the second heat exchanger are of cylindrical shape, and the heat exchange surface surrounds the line portion, and/or
wherein the heat transfer fluid circulates in a direction opposite to a flow direction of the exhaust gases in the line portion.

20. A method for thermally managing a motor vehicle equipped with a fuel cell, an electric motor, a combustion engine, an aftertreatment system for exhaust gases of the combustion engine, and the thermal system as claimed in claim 11, the method comprising an iteration of the following steps:
a first step E1 of thermally managing an operating phase of the fuel cell and of the electric motor, then
a second step E2 of anticipating when the combustion engine and the aftertreatment system will next be started, then
a third step E3 of thermally managing an operating phase of the combustion engine and of the aftertreatment system, then
a fourth step E4 of anticipating when the fuel cell will next be started,
wherein the second step E2 comprises an implementation of the first circulation of heat transfer fluid.

21. A non-transitory computer readable medium storing a program that, when executed by a computer, causes the computer to execute the thermal management method as claimed in claim 20.

22. A method for thermally managing a motor vehicle equipped with a fuel cell, an electric motor, a combustion engine, an aftertreatment system for exhaust gases of the combustion engine, and the thermal system as claimed in claim 13, the method comprising an iteration of the following steps:
a first step E1 of thermally managing an operating phase of the fuel cell and of the electric motor, then
a second step E2 of anticipating when the combustion engine and the aftertreatment system will next be started, then
a third step E3 of thermally managing an operating phase of the combustion engine and of the aftertreatment system, then
a fourth step E4 of anticipating when the fuel cell will next be started,
wherein the second step E2 comprises an implementation of the first circulation of heat transfer fluid and an implementation of the fifth circulation of heat transfer fluid.

23. The thermal management method as claimed in claim 22, wherein
the first step E1 and the second step E2 comprise an implementation of the second circulation and of the fourth circulation of heat transfer fluid, and/or
the third step E3 and the fourth step E4 comprise an implementation of the third circulation of heat transfer fluid, and/or
the fourth step E4 comprises an implementation of the sixth circulation and/or of the seventh circulation of heat transfer fluid.

24. A non-transitory computer readable medium storing a program that, when executed by a computer, causes the computer to execute the thermal management method as claimed in claim 22.

25. A motor vehicle comprising:
the thermal system as claimed in claim 11.
